(19) United States
(12) Patent Application Publication
(10) Pub. No.: US 2002/0148556 A1
(43) Pub. Date: Oct. 17, 2002

(54) Labeling method and hand labeler therefor

(76) Inventor: Toshikazu Kawada, Tokyo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/126,612

(22) Filed: Apr. 22, 2002

Related U.S. Application Data
(62) Division of application No. 09/644,814, filed on Aug. 24, 2000.

(30) Foreign Application Priority Data
May 2, 2000 (JP) 2000-133898

(51) Int. Cl. B32B 31/00

(52) U.S. Cl. 156/250; 156/277; 156/387; 156/510; 156/529; 156/578; 156/577

(57) ABSTRACT

Disclosed is a hand labeler having: a printer mechanism responsive to the gripping of the handle for printing pieces of information on one side of a continuous narrow length such as a length of tape; a feeding mechanism for feeding the continuous narrow length a predetermined distance in a given direction; and a cutter mechanism for cutting the so fed part of continuous narrow length when the handle is released to allow it to return to its stress-free position; and applying means for applying an adhesive agent such as glue to the other side of the so fed part of continuous narrow length. The continuous narrow length has no liner applied on the other side.

### BACKGROUND OF THE INVENTION

1. Field of the Invention

The present invention relates to an improvement in or relating to a hand labeler which is capable of preparing and applying labels to goods one after another, and a labeling method according to which labels are prepared from a continuous narrow length having no release liner applied to its rear side to apply the so prepared labels to goods one after another.

2. Related Arts

One example of such hand labeler is disclosed in Japanese Utility Model 61-11509(A). The hand labeler uses a series of labels applied on a length of release liner, and the device peels labels off from the length of release liner one after another to apply the so peeled-off labels to goods one after another.

After labeling, a lot of release liner remains to be thrown away. This requires extra cost involved for using and finally throwing away liner material.

### SUMMARY OF THE INVENTION

One object of the present invention is to provide a labeling method and a labeler permitting use of liner-free continuous narrow length to provide labels.

To attain this object a labeling method for applying labels to objects such as goods according to the present invention comprises the steps of: printing pieces of information such as cost on a continuous narrow length on one side to feed it a predetermined distance in a given direction subsequent to each printing; making the other side of each information bearing length thus fed sticky with the aid of applying means by applying an adhesive agent such as glue, or by applying a liquid-phase additive such as water, plasticizer, activator or solvent to the continuous narrow length having a sticky material already applied to the other side, the required application being effected simultaneously with, before or after the feeding of the continuous narrow length; cutting and separating each information bearing length from the continuous narrow length to provide individual labels; and applying the so provided individual labels to objects one after another.

The applying means may comprise: brushing or atomizing means for applying an adhesive agent or a liquid-phase additive such as water, plasticizer, activator or solvent to each information bearing length; and heating and/or pressing means for heating the each information bearing length at a predetermined temperature and/or applying a predetermined pressure thereto for example with the aid of rolls, thereby increasing the adhesive strength or activating the adhesive action.

The continuous narrow length may be a length of paper tape having no release liner or backing liner applied to its rear side.

A hand labeler according to the present invention comprises: a printer mechanism responsive to the gripping of the handle for printing pieces of information on one side of a continuous narrow length; a feeding mechanism for feeding the continuous narrow length a predetermined distance in a given direction; and a cutter mechanism for cutting the so fed part of continuous narrow length when the handle is released to allow it to return to its stress-free position.

The hand labeler may further comprise applying means for applying an adhesive agent such as glue to the other side of the so fed part of continuous narrow length.

The hand labeler may further comprise applying means for applying to the other side of the so fed part of continuous narrow length a liquid-phase additive such as water, plasticizer, activator or solvent.

The hand labeler may further comprise heating means for heating the so fed part of continuous narrow length at a predetermined temperature thereby increasing the adhesive strength.

The hand labeler may further comprise roll means for applying a predetermined pressure to the so fed part of continuous narrow length, thereby activating the adhesive action.

The continuous narrow length may be a length of tape having adhesive agent such as glue encapsulated and spread on the other side or a length of tape having an adhesive agent applied on the other side, and liquid-phase additive such as water, plasticizer, activator or solvent encapsulated and spread on the other side.

A hand labeler for printing, cutting and separating a length of tape into individual labels, the tape having adhesive agent such as glue applied or encapsulated and spread on the rear side opposite to the front side on which pieces of information are to be printed, or the tape having an adhesive agent applied on the rear side, and liquid-phase additive such as water, plasticizer, activator or solvent encapsulated and spread on the rear side, is so configured according to the present invention that micro-capsules are destroyed with pressure applying means such as rolls to activate the adhesive agent applied on the length of tape, and that the length of tape is cut a predetermined length sequentially to apply individual labels thus provided to goods one after another.

The labeling method according to the present invention uses no carrier strip bearing labels in the form of liner, thus saving extra material finally thrown away, which is advantageous both from the point of economical view and from the point of resource saving view.

The labeling method according to the present invention is described below:

At the first step pieces of information such as cost are printed on a continuous narrow length on one side. The continuous narrow length is an elongated strip of liner-free paper having sticky material spread on one side, which is referred to as “adhesive tape”.

Examples of such adhesive tape are: (1) an elongated strip having glue applied to one side (referred to as “dry glue-applied tape”); (2) an elongated strip having thermoplastic adhesive agent applied to one side (referred to as “thermoplastic adhesive tape”); and (3) an elongated strip having an adhesive agent encapsulated and spread on one side or having a liquid-phase additive such as water, plasticizer, activator or solvent encapsulated and spread on one side on which a certain adhesive agent is applied to be activated in adhesive action when met with such additive (referred to as “encapsulating type of adhesive tape”).

A printer for printing pieces of information on a continuous narrow length may use an endless belt carrying the elongated strip to the printing station.

At the second step the tape having pieces of information printed on the other side is fed a predetermined distance in a desired direction by squeezing the handle of a hand labeler, thereby driving a reciprocating block forward while catching the tape or driving a unidirectional endless belt in only one direction for moving the tape forth.

At the third step an adhesive agent or a liquid-phase additive such as water, plasticizer, activator or solvent is applied to the adhesive-applied side of the tape. This may be effected at the second step, specifically just prior to the feeding of the tape to the cutting position.

Different applying means may be used depending on what kind of tape is used. Some examples of applying means are: glue applying means such as a brush or atomizer; liquid applying means for spreading water, plasticizer, activator or solvent on the adhesive-applied side of the tape; and roll means for applying a predetermined pressure to the adhesive -applied side of the tape, thereby activating the adhesive action. In addition, heater means may be used for heating the tape at a predetermined temperature, thereby increasing the adhesive strength.

At the fourth step the tape is cut a predetermined length to provide a label to be applied to a selected object such as a good. Preferably the cutting may be effected subsequent to the third step at which adhesive agent is applied to the tape, but if occasion demands, the cutting may be effected prior to application of adhesive agent to the tape.

One example of cutting device for separating each information bearing piece from the tape is a cutter installed in a hand labeler, the blade of which cutter is raised and lowered by gripping and releasing the handle. Specifically the tape can be cut with the cutter blade in the vicinity of the printing station when the handle is released, as described later.

As may be understood from the above, every time the continuous narrow length may be fed a predetermined distance, it is printed on one side to be cut into pieces each having pieces of information printed on one side, and each piece is made sticky on the other side for instance by applying glue thereto ahead of the cutting station. Liner material such as release liner or backing paper, which must be thrown away after use, therefore, is not heaped.

A hand labeler according to the present invention is described below with reference to the accompanying drawings.

### BRIEF DESCRIPTION OF THE DRAWING

FIG. 1 is a perspective view of a hand labeler according to a first embodiment of the present invention, with one side plate removed to show inside;

FIG.2 is a side view of the hand labeler;

FIG.3 is an exploded view of the major parts of the hand labeler;

FIG.4 is a longitudinal section of a fragment of the hand labeler, illustrating adhesive agent applying mechanism;

FIG.5 illustrates that the printing face is applied to the ink pad in the hand labeler;

FIG.6 illustrates that the cutter is raised in the hand labeler;

FIG. 7 illustrates how the printing is effected, allowing the reciprocating block of the tape feeding mechanism to return to its rearward position in the hand labeler;

FIG. 8 illustrates that the reciprocating block of the tape feeding mechanism is moved to its forward position to feed the tape a predetermined distance in the hand labeler;

FIG. 9 is a perspective view of a hand labeler according to a second embodiment of the present invention;

FIG. 10 is a side view of the hand,labeler;

FIG. 11 is an exploded view of the belt-and-ratchet assembly of the hand labeler;

FIG. 12 is an exploded view of the cutting mechanism of the hand labeler;

FIG. 13 illustrates that the printing face is applied to the ink pad in the hand labeler;

FIG. 14 illustrates that the cutter blade is raised in the hand labeler;

FIG. 15 illustrates how the printing is effected in the hand labeler;

FIG. 16 a perspective view of a hand labeler according to a third embodiment of the present invention;

FIG. 17 is a side view of the hand labeler;

FIG. 18 is an exploded view of the major parts of the hand labeler;

FIG. 19 is an exploded view of the mechanism using rolls for pressing and activating the adhesive-applied surface of the tape;

FIG. 20 is an exploded view of the upright cutting mechanism of the hand labeler;

FIG. 21 illustrates how the vertical cutter works in the hand labeler;

FIG. 22 illustrates that the printing face is applied to a selected roll in the hand labeler;

FIG. 23 illustrates that the cutter blade is raised in the hand labeler; and

FIG. 24 illustrates that the tape feeding mechanism to return to its rearward position in the hand labeler.

### DETAILED DESCRIPTION OF PREFERRED EMBODIMENT

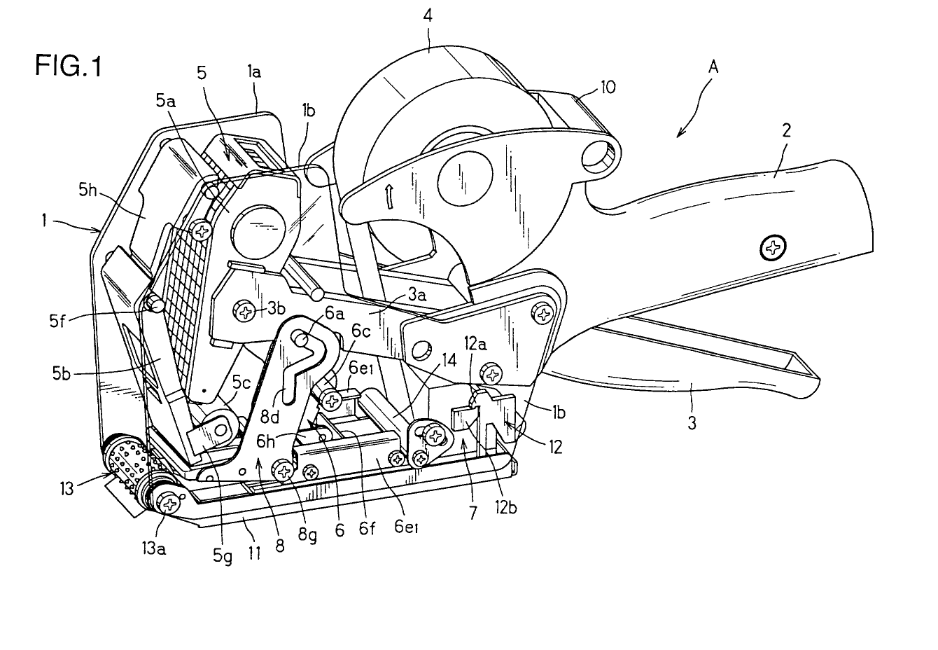

Referring to FIGS, 1 to 8, particularly FIG. 1 among these drawings a hand labeler A according to a first embodiment of the present invention comprises: a handle 3 rotatably fixed to the labeler body 1 in confronting relation with the grip shank 2 of the labeler body 1; a handle-operated printer mechanism 5 responsive to the gripping of the handle 3 for printing pieces of information on one side of a length of liner-free tape 4; a feeding mechanism 6 for feeding the liner-free tape a predetermined distance in a given direction; an adhesive applicator mechanism 7 for making the other side each of the information-bearing parts of the liner-free tape 4; and a cutter mechanism 8 for cutting the so fed tape when the handle 3 is released to allow it to return to its stress-free position.

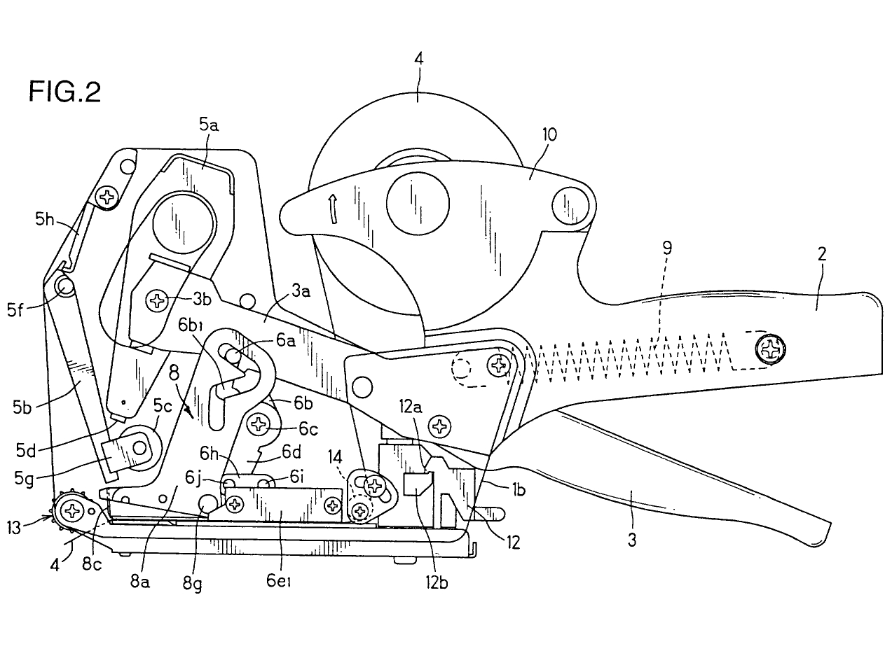

The handle 3 can be rotated toward the stationary shank grip 2 when the handle 3 is gripped, and can be rotated apart from the grip shank 2 under the influence of spring 9 when the handle 3 is released, as seen from FIG. 2.

The liner-free tape 4 is wound into a roll, which is rotatably held by a tape holder 10.

The handle-operated printer mechanism 5 comprises a printing head 5a bolted with screws 3b to the free end of a rotary arm 3a integrally connected to and extending from the handle 3, an ink pad supporter 5b responsive to the action of the printing head for swinging back and forth, and an ink pad 5c rotatably fixed to the lower end of the ink pad supporter 5b.

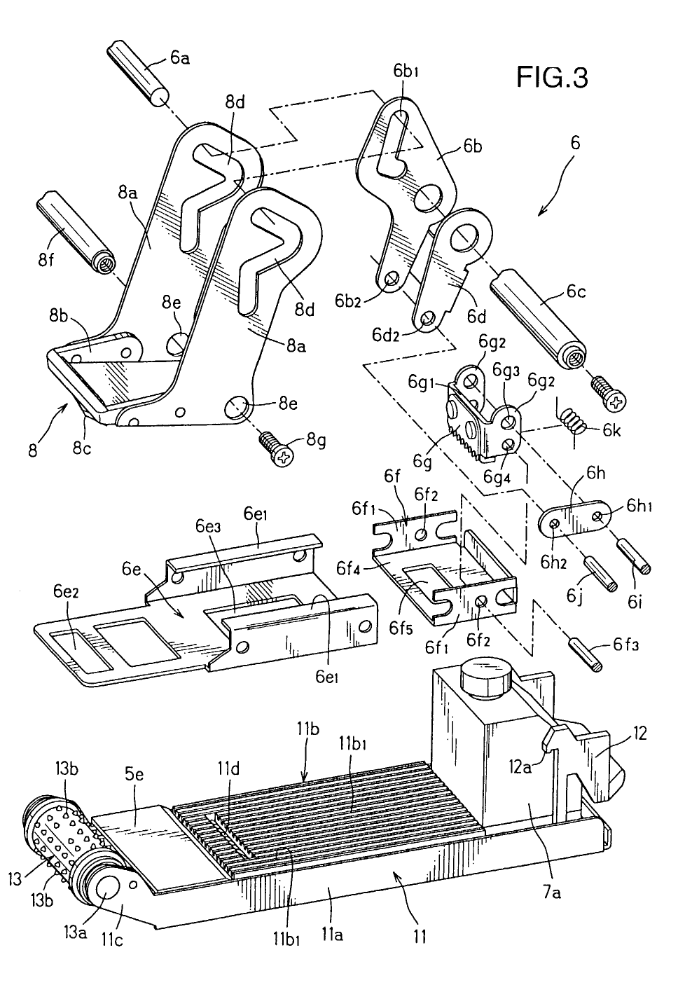

The printing head 5a is of ordinary endless-belt type, using an endless belt having a series of type faces representing pieces of information formed thereon. A selected type face 5d (see FIG. 2) is lowered and raised from a flat stamping plate 5e (see FIG. 3) in response to the movement of the rotary arm 3a.

The ink pad supporter 5b is hanged from the cross rod 5f traversing between the front ends of the opposite side plates 1a and 1b of the labeler body 1, and it has a replaceable ink pad 5c rotatably fixed to its lower end.

The ink pad supporter 5b is spring-biased inward by a resilient piece 5h of synthetic or other flexible material, thereby putting the ink pad 5c inward in the labeler body 1.

Specifically further depression of the printing head 5a subsequent to the abutment of the type face 5d against the ink pad 5c drives the ink pad supporter 5c away, and then, the ink pad supporter 5c is pushed inward by the resilient piece 5h to follow the rise of the printing head 5a toward its original position when the handle 3 is released.

Referring to FIG. 3, the feeding mechanism 6 comprises a cam plate 6b operatively connected to the rotary arm 3a of the handle 3 via an associated cam axle 6a in the form of stud rod upright on the rotary arm 3a, a tape feeding lever 6d which can rotate about the cam axle 6a, a slider 6f responsive to rotation of the tape feeding lever 6d for moving back and forth on a tape guide plate 6e, which slidably accommodates the slider 6f, and a feeding nail piece 6g operatively connected to the slider 6f.

The cam plate 6b has a hook-like slot 6b, made therein. Depression of the front end of the rotary arm 3a causes the cam axle 6a to incline the upper end of the tape feeding lever 6d forward, moving the slider 6f backward.

As seen from FIG. 3, the tape guide plate 6e has parallel rails 6e₁, formed on its opposite upper longitudinal edges, and a stamping aperture 6e₂and a nail window 6e₃made on its bottom. The stamping aperture 6e₂ confronts the underlying stamping plate 5e whereas the nail window 6e₃ allows the segregated nail 6g to appear on the bottom of the slider 6e.

The slider 6f is slidably fitted in between the parallel rails 6e₁, and the feeding nail piece 6g is swingably attached to the slider 6f by inserting a cross pin 6f₃ in the apertures 6f₂ made in the opposite sides 6f and the lower apertures 6g₄ of the feeding nail piece 6g. As seen from FIG. 3, the slider 6f has a window opening 6f₅ made on its bottom 6f₄, thereby allowing the angular inclination of the segregated nail.

The feeding nail piece 6g is swingably connected both to the tape feeding lever 6d and the swingable slider 6f via an associated swingable piece 6h. Specifically the feeding nail piece 6g is connected to the swingable piece 6h, the cam plate 6b and the tape feeding lever 6d by inserting a cross pin 6i in one aperture 6h₁ of the swingable piece 6h, the apertures 6g₃ of the opposite sides 6g₂ of the feeding nail piece 6g, and by inserting another cross pin 6ⱼ in the other aperture 6h₂ of the swingable piece 6h, the lower aperture 6d₂ of the tape feeding lever 6d and the lower aperture 6b₂ of the cam plate 6b.

This arrangement permits the feeding nail piece 6g to remain together with the slider 6f on the front side of the labeler body 1 while the handle 3 is not gripped (in inoperative position; see FIG. 2). When the handle 3 is griped towards the shank extension 2 to incline the tape feeding lever 6d, the feeding nail piece 6g with its posture upright relative to the underlying tape 4 is moved back, and it is inclined upward as the swingable piece 6h is tilted upward. This action is performed on the way to the final rearward point (called the “backward travel”). When the handle 3 is released to move apart from the shank extension 2, the feeding nail piece 6g is allowed to return to its upright position under the influence of an associated spring 6k, catching the underlying tape 4 with its segregation to feed the tape a predetermined distance (called “forward travel”).

Specifically the feeding nail piece 6g is spring-biased with the spring 6k to be put in contact with the underlying tape 4. When the swingable slider 6f is withdrawn to follow the gripping of the handle 3, the feeding nail piece 6g is tilted to leave the underlying tape 4, thereby preventing the feeding nail piece 6g from catching and taking backward the underlying tape 4. After printing the feeding nail piece 6g is allowed to return to its initial position in which the feeding nail piece 6g is put in contact with the underlying tape 4, and then, the underlying tape 4 is fed forward again.

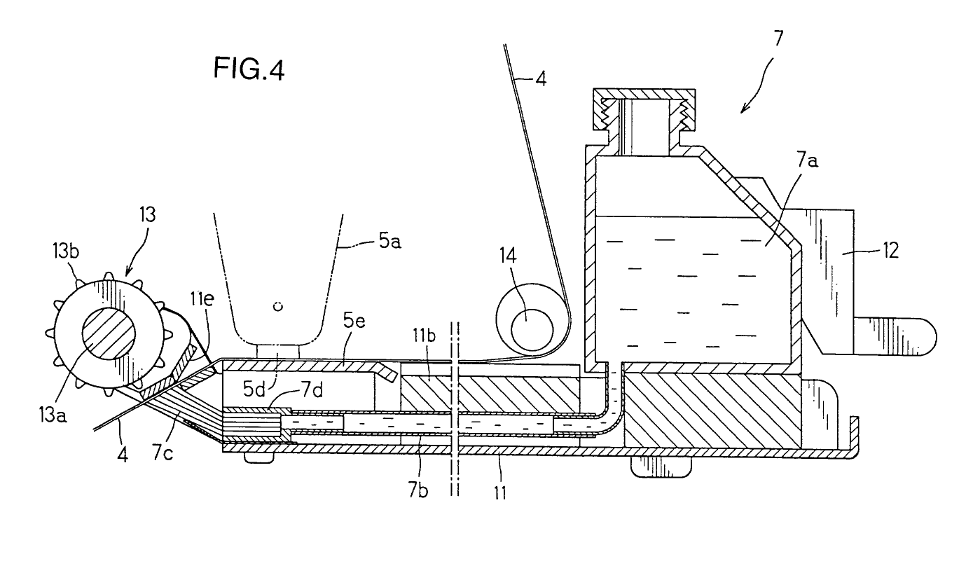

Referring to FIG. 4, the adhesive applicator mechanism 7 for making the rear side each of the printed parts of the length of liner-free tape 4 comprises a liquid-phase agent tank 7a standing upright from the rear end of the bottom lid plate 11 of the housing, and an applicator 7c communicating with the tank via an associated conduit 7b. The tank 4 contains a liquid-phase additive such as water, plasticizer, activator or solvent, which is fed to the applicator 7c under the water pressure in the tank 7a. It may be fed with the aid of pump.(not shown).

The conduit 7b is laid on the upper surface of the bottom lid plate 11, and is covered with a guide plate 11b.

The applicator 7c may be a brush made with a lot of hairs, which is fixed to the forward end of the bottom lid plate 11 by a holder piece 7d with the hairs applied to the rear side of the length of tape 4.

Referring to FIG. 3, the cutter mechanism 8 comprises two opposite hook-like side link plates 8a operatively connected to the rotary arm extension 3a and a U-shaped cutter blade 8c having two opposite parallel supports 8b fixed to the opposite side link plates 8a. Each hook-like side link plate 8a has a cam slot 8d made therein for guiding an associated cam axle 6a and a pivot aperture 8e at its lower rear corner for inserting a tapped pivot rod 8f, which is loosely fastened with a screw 8g.

The U-shaped cutter blade 8c is attached to the lower, forward projections of the opposite side link plates 8a. When the opposite side link plates 8a turn about the pivot rod 8f, the cutter blade 8c is tilted and pushed down to cut the tape 4.

The cam slots 8d permit the cutter 8c and the feeding mechanism 6 to cooperate with each other in such a way that the tape feeding may be put in unison with the tape cutting.

The bottom lid plate 11 is so attached to the bottom of the labeler body 1 that it may turn about one end for opening and closing the bottom of the labeler body 1. Specifically the bottom lid plate 11 is composed of a rectangular plate having two longitudinal side walls 11a standing upright from its longitudinal edges, two front inclinations 11c integrally connected to the front ends of the opposite longitudinal side walls 11a, a stamping plate 5e traversing the front side of the rectangular space defined by the opposite side walls and the bottom of the rectangular plate, and a guide plate 11b fitted inthe rectangular space. The guide plate 11b has a plurality of longitudinal guide grooves and a traversing guide slot lid made on its front side for directing the free end of the tape length .upward.

The parallel guide grooves 11b₁ are arranged at the same interval as the teeth of the segregated nail piece 6g. These guide grooves 11b₁ are useful in guiding the tape forward in cooperation with the segregated nail piece 6g, which catches and feeds the tape forward.

A press roll 13 is rotatably attached to the opposite support inclines llc integrally connected to the front ends of the opposite longitudinal side plates 11a of the bottom lid plate 11. The press roll 13 can rotate about its pivot axle 13a traversing between the opposite support inclines 11c. The bottom lid plate 11 is rotatably fixed by its front end to the labeler body so that it may be rotated to close the bottom opening of the labeler body. Specifically the bottom lid plate 11 has a rotary lock member 12 rotatably fixed to its rear end, and the bottom lid plate 11 can be retained in its closing position by rotating the rotary lock members 12 and by allowing their engagement pieces 12a to be caught by the counter catch piece s12b formed on the opposite side plates 1b (see FIG. 1).

The press roll 13 is a flexible roll having numerous projections 13b formed on its surface, and is used for pushing the tape 4 to a selected object.

The so constructed hand labeler A can be operated as follows: first, a tape roll 4 is loosely fitted in the tape retainer 10 by inserting its center pin in the center hole of the tape roll 4, and then, one side plate 1b is removed to expose the inside of the labeler body. The tape 4 is made to go round the lower roll 14 (see FIG. 4), extending on the longitudinal guide plate 11b of the bottom lid plate 11 under the tape guide plate 6e and on the teeth of the counter nail lid and the stamping plate 5e to run under the guide piece 11e and the press roll 13, finally appearing ahead of the front end of the hand labeler body. The side plate 1b is press-fitted on one side of the hand labeler, and the bottom lid plate 11 is rotated to its closing position to be fastened with latch (tape setting finished).

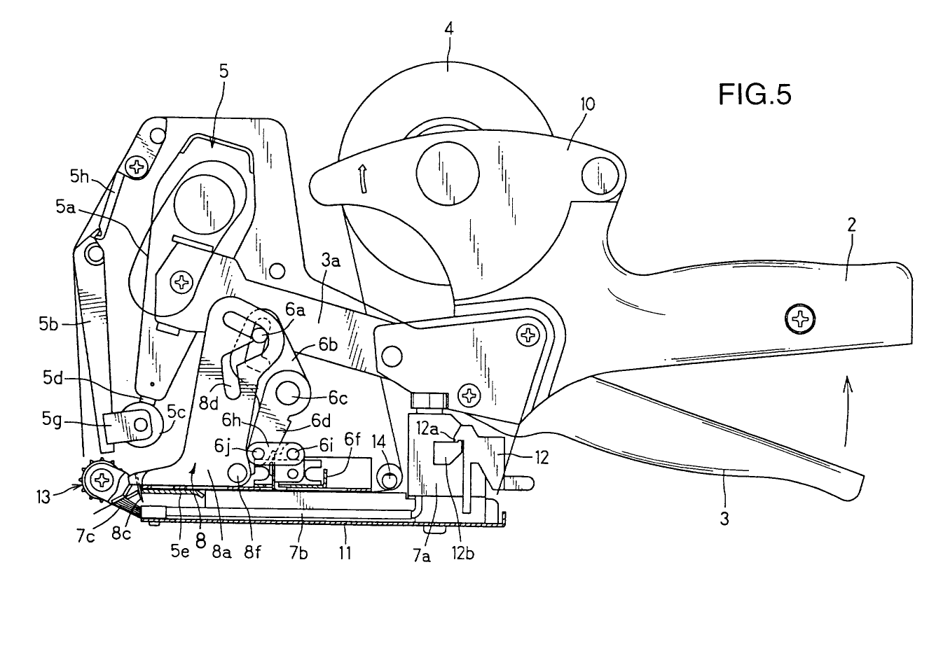

Then, the handle 3 is griped to move one third angular distance toward the shank extension 2, thereby inclining the rotary arm 3a about its pivot to allow the printing head 5d to abut on the ink pad 5c (see FIG. 5).

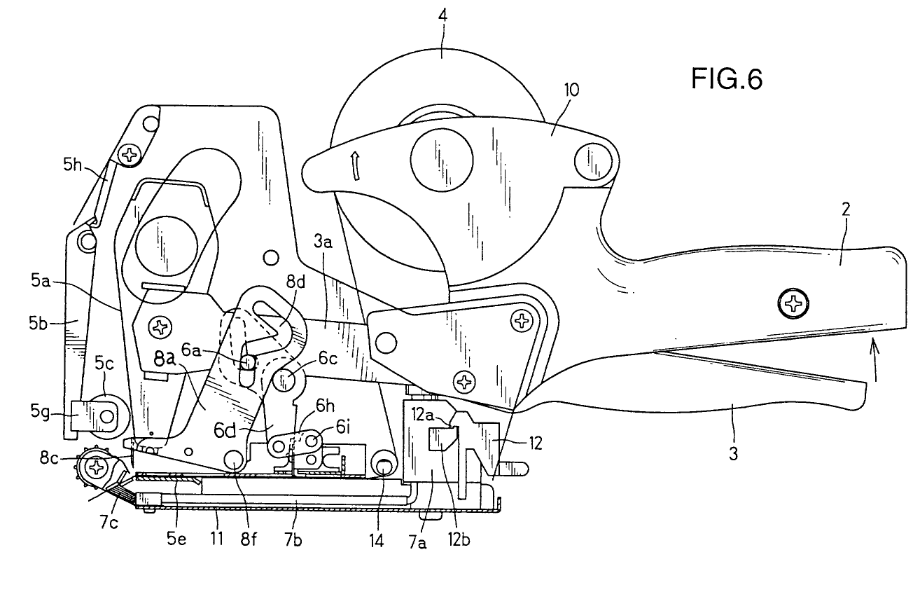

Another one-half angular gripping of the handle 3 makes the printing head 5d to descend and drive the ink pad 5c apart from the way, and at the same time the cam link plates 8a is tilted about their pivot 8f to raise their lower, front ends, and hence the cutter blade 8c (see FIG. 6).

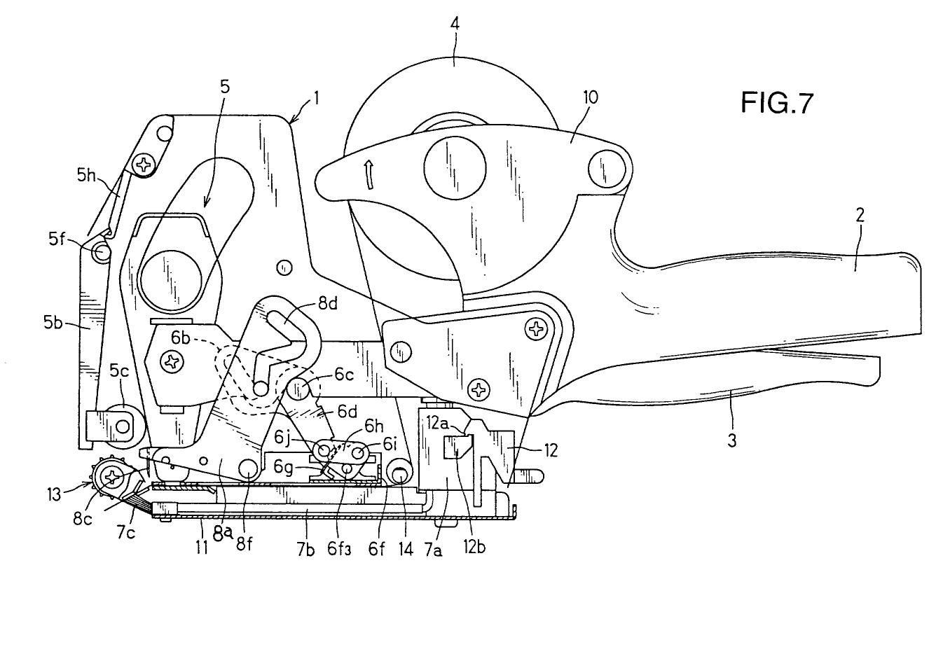

When the handle 3 is completely gripped to lie on the shank extension 2, the feeding lever 6d moves to withdraw the slider 6f backward, and at the same time, the segregated nail 6g is raised upward through the agency of the joint piece 6h, which is inclined to raise its rear end by the feeding lever 6d. While this sequence proceeds, the tape 4 is printed (see FIG. 7).

Then, the handle 3 is released to be one half angular distance apart from the shank extension 2, the tape feeding nail 6g is allowed to return to its initial upright posture under the influence of the spring 6k to catch the tape 4 with its teeth, and the slide 6f is displaced forward to feed the tape 4 a predetermined distance equal to the label size.

At the same time, glue is applied to the rear side of the predetermined length of the tape thus fed.

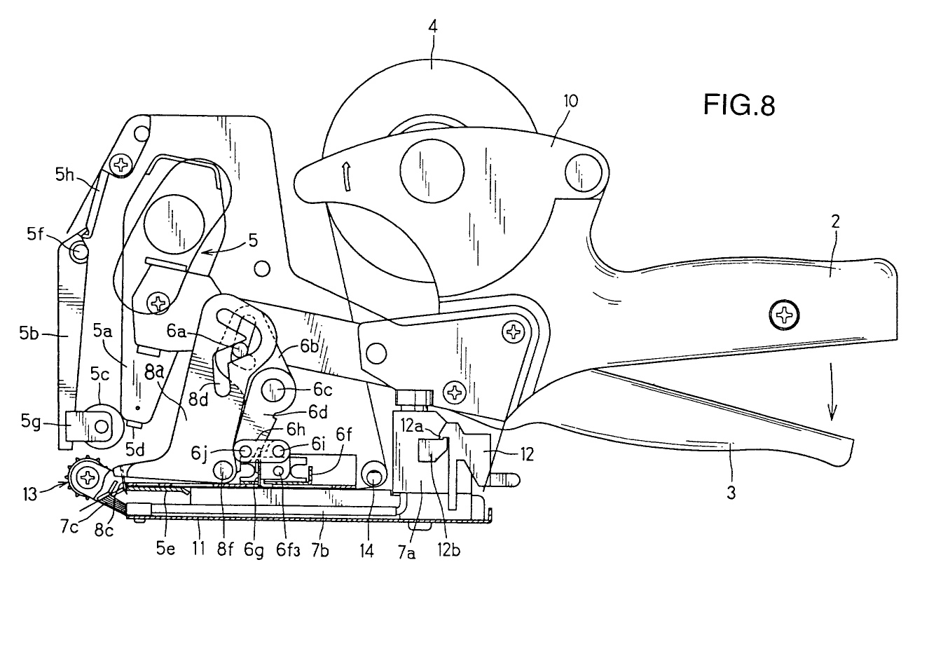

Further opening of the handle 3 causes the side link plates 8a to be inclined, lowering their front ends and hence the cutter blade 8c to cut the tape 4 close to the printing (see FIG. 8). The so separated piece is applied to a selected object as a label. When the handle 4 is completely released, every part is allowed to return to its initial stand-by position.

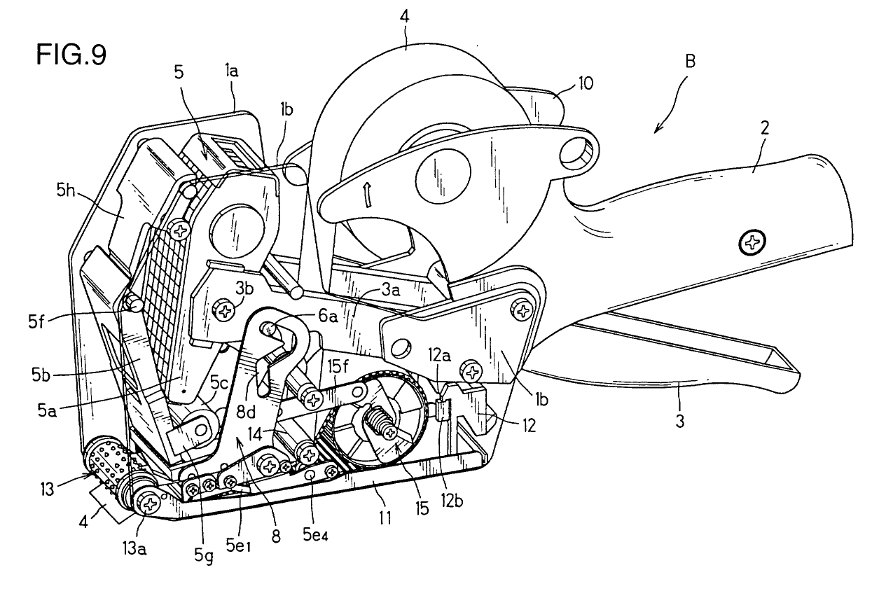

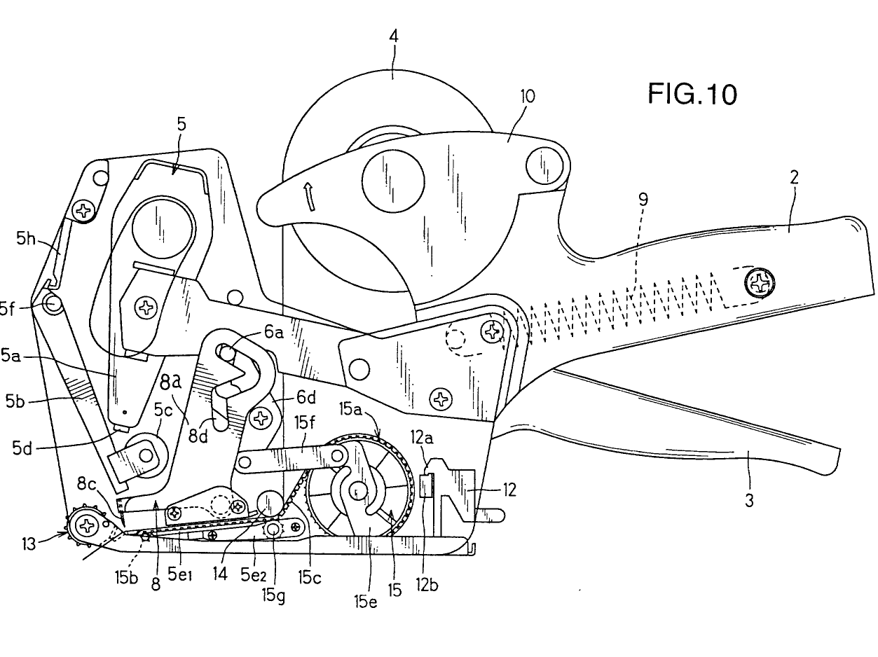

FIGS. 9 to 15 show a hand labeler according to the second embodiment of the present invention. These drawings show same parts as the hand labeler according to the first embodiment by same reference numerals as used in FIGS. 1 to 8.

Referring to FIG. 9, an endless belt type of hand labeler B uses a ratchet wheel-and-endless belt arrangement for feeding a length of tape in only one direction in place of the feeding mechanism using the toothed nail-and-slider assembly in the first embodiment.

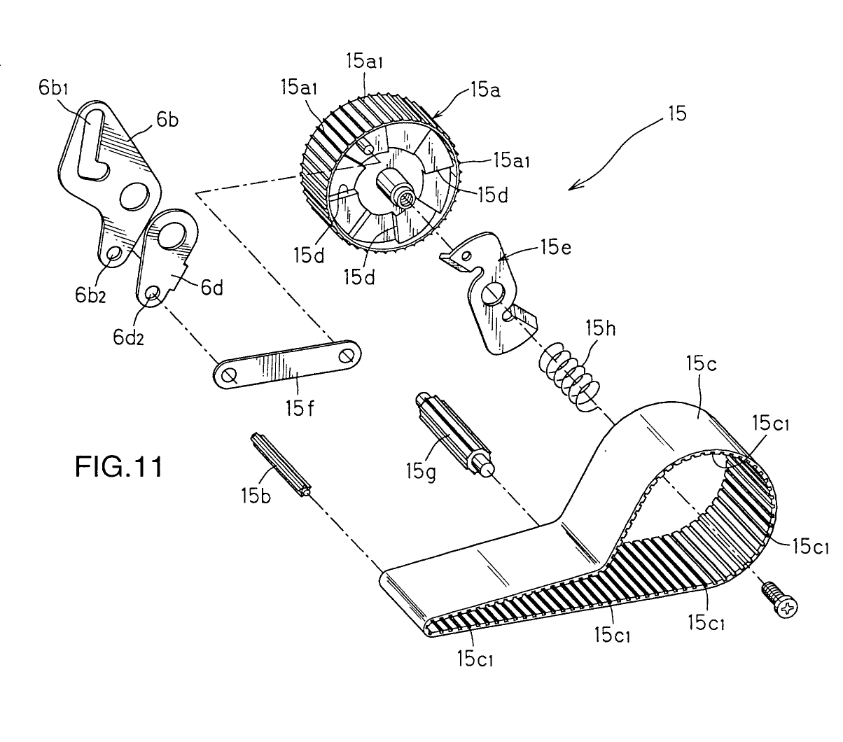

Referring to FIG. 11, the ratchet wheel-and-endless belt arrangement comprises a large rotary wheel 15a and an associated ratchet nail 15e, a small pinion 15b placed in the vicinity of the cutter blade 8c, and an endless belt 15c extending between the large rotary wheel 15a and the small pinion 15b. The rotary wheel 15a has inclined blades 15d fixed inside, and the ratchet nail 15e is loosely fixed to the center axle of the rotary wheel 15a with screw via a spring 15h. The ratchet nail 15e is so engaged with the inclined blades 15d of the rotary wheel 15a as to permit movement of the wheel 15a in only one direction.

Also, the rotary wheel 15a has teeth 15a₁ formed on its outer circumference. The rotary wheel 15a is combined with the endless belt 15c by winding the endless belt 15c round the rotary wheel 15a with the circumference teeth 15a₁ meshed with the inner teeth 15c₁of the endless belt 15c.

The rotary wheel 15a is operatively connected to the feeding lever 6d via a joint piece 15f by inserting a stud pin in one hole made at the rear end of the joint piece 15f and by inserting a pin in the other hole made at the front end of the joint piece 15f. When the handle 3 is gripped to move the cam plate 6b, the ratchet nail 15e is intermittently moved in only one direction, thereby allowing the rotary wheel 15a to rotate a predetermined angle as later described in detail.

The endless belt 15c goes round the rotary wheel 15a and the gear pin 15b to be stretched by pushing the endless belt 15c with an intermediate toothed rod 15g.

The endless belt 15c is equipped with an electric heater (not shown) for raising the temperature at the tape abutting area, thereby enhancing the adhesive power of the information bearing length. The electric heater is connected to an electric power supply such as a battery.

The ratchet nail 15e is resiliently pushed against radial blades 15d, permitting it to be engaged with selected radial blades 15d in only one direction and disengaged from any radial blades in the other direction.

Specifically the gripping of the handle 3 toward closing position causes the ratchet nail 15e to turn clockwise without being caught by any radial blades 15d. In contrast, the releasing of the handle 3 toward opening position causes the ratchet nail 15e to turn counterclockwise while being caught by selected radial blades 15d, thus rotating the wheel 15a to feed the tape forward via the endless belt 15c.

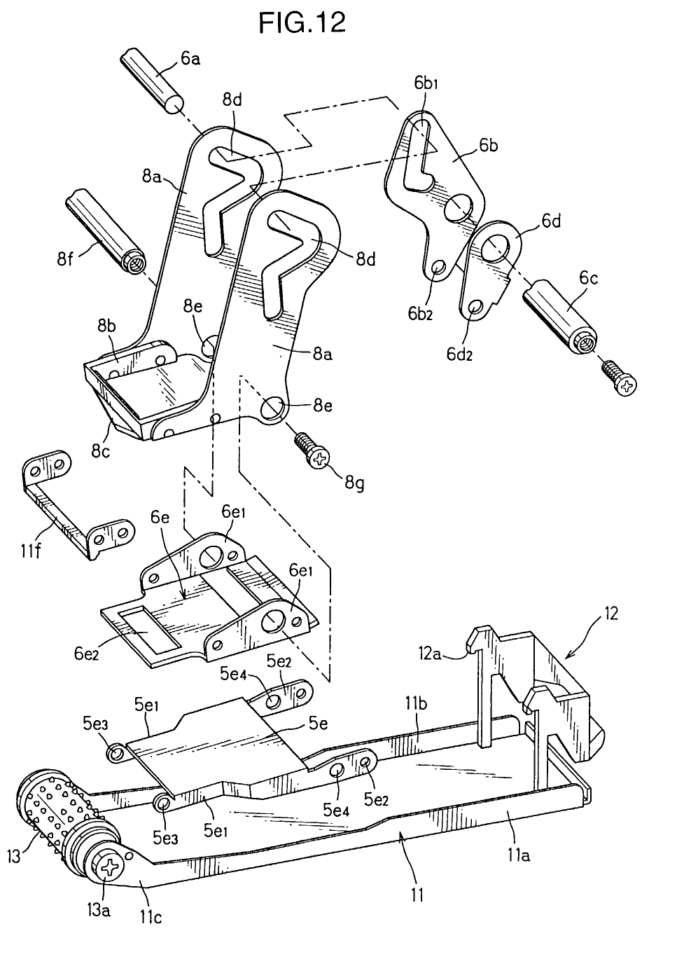

Referring to FIG. 12, the stamping plate 5e has two parallel support arms 5e₁ and 5e₂ formed on its front and rear sides. These support arms 5e₁ and 5e₂ have holes 5e₃ and 5e₄ made therein, and the pinion 15b and intermediate toothed rod 15g are loosely inserted in the holes 5e₃ and 5e₄ of the support arms 5e₁ and 5e₂.

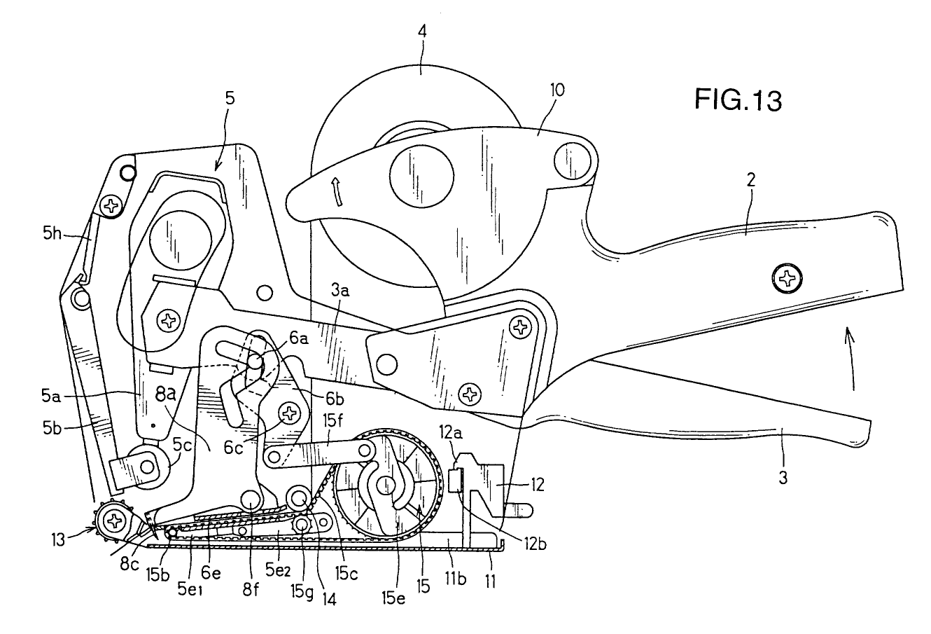

In operation, the handle 3 is griped to move about one third (⅓) angular distance toward the shank extension 2, thereby inclining the rotary arm 3a about its pivot to allow the type face 5d to abut on the ink pad 5c (see FIG. 13).

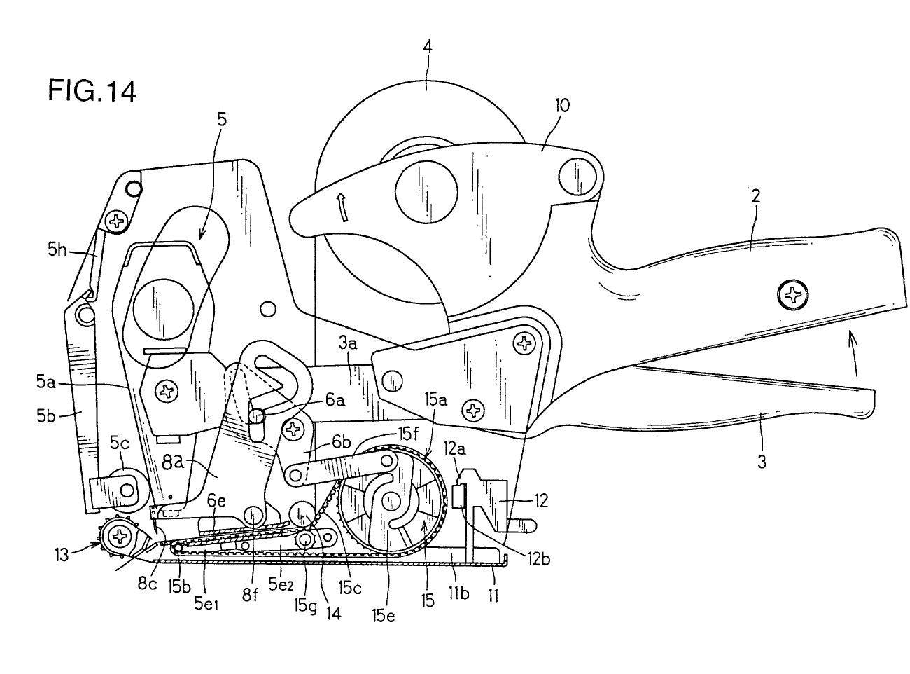

Another one-half (½) angular gripping of the handle 3 makes the type face 5d to descend and drive the ink pad 5c apart from the way, and at the same time the cam link plates 8a are tilted about their pivot 8f to raise their lower, front ends, and hence the cutter blade 8c (see FIG. 14).

Then, the ratchet nail 15e turns clockwise without being caught by radial blades 15d, thus allowing the rotary wheel 15a to remain still.

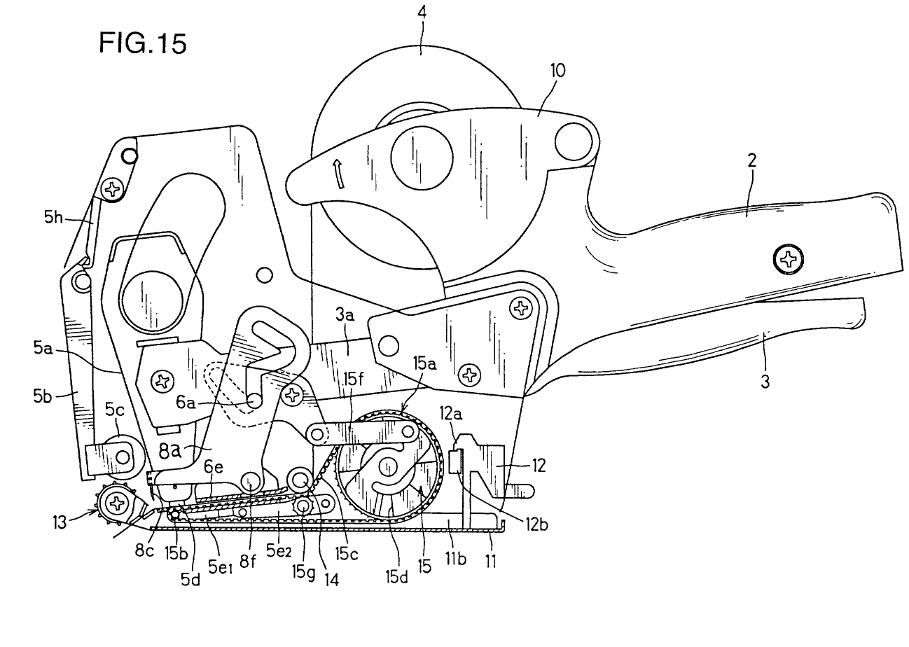

When the handle 3 is completely gripped to lie on the shank extension 2, the ratchet nail 15e rotates freely clockwise, and at the same time, the type face 5d is descended still further to print on the tape 4 (see FIG. 15).

Then, the handle 3 is released to be about one half (½) angular distance apart from the shank extension 2, the ratchet nail 15e turns counterclockwise to be caught by selected radial blades 15d, thus rotating the rotary wheel 15a to feed the tape 4 a predetermined distance equal to the label size via the endless belt 15c.

At the same time, the predetermined length of tape thus fed (thermoplastic adhesive tape) is heated at a prescribed temperature to make its rear side sticky.

Further opening of the handle 3 causes the side link plates 8a to be inclined, lowering their front ends and hence the cutter blade 8c to cut the tape 4 close to the printing. The so separated piece is applied to a selected object as a label. When the handle 4 is completely released, every part is allowed to return to its initial stand-by position.

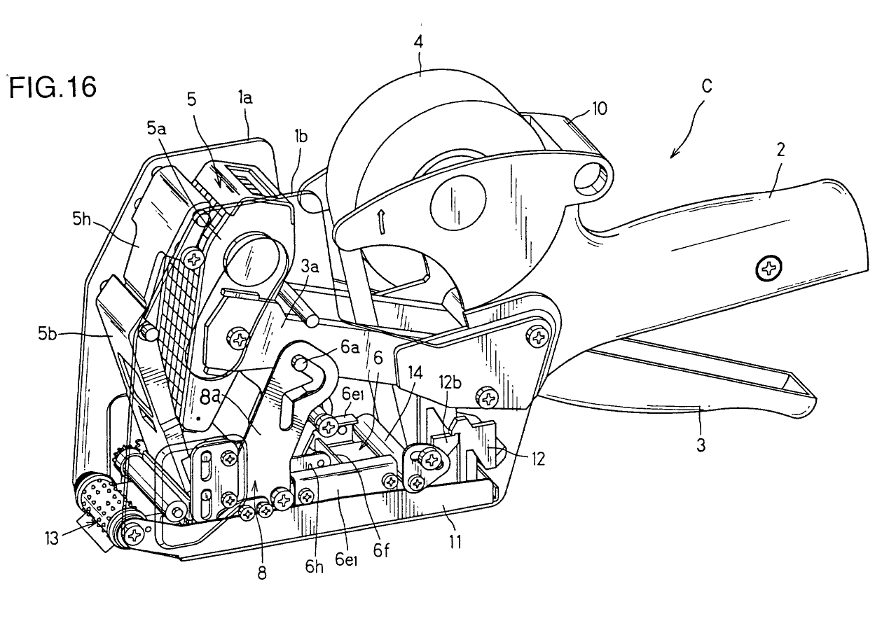

FIGS. 16 to 25 show a hand labeler according to the third embodiment of the present invention. These drawings show same parts as the hand labeler according to the first and second embodiments by same reference numerals as used in FIGS. 1 to 8, and 9 to 15.

Referring to FIG. 16, an endless belt type of hand labeler C uses a press roll adhesive-activating mechanism 16 for making a length of tape having an adhesive agent encapsulated and spread on its rear side or an adhesive-activating additive encapsulated and spread in the agent coating of the rear side of the tape sticky by pressing and breaking micro-capsules.

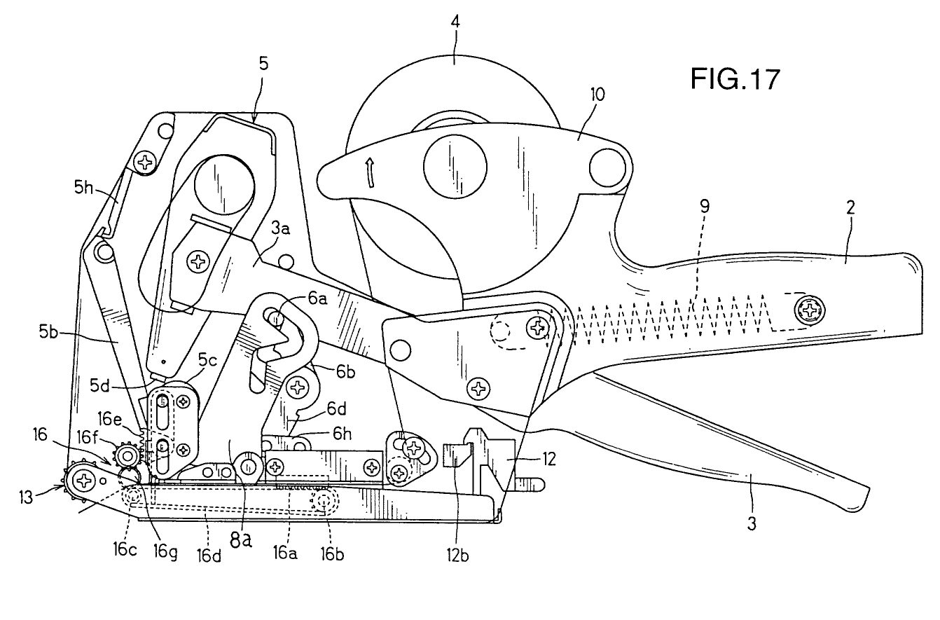

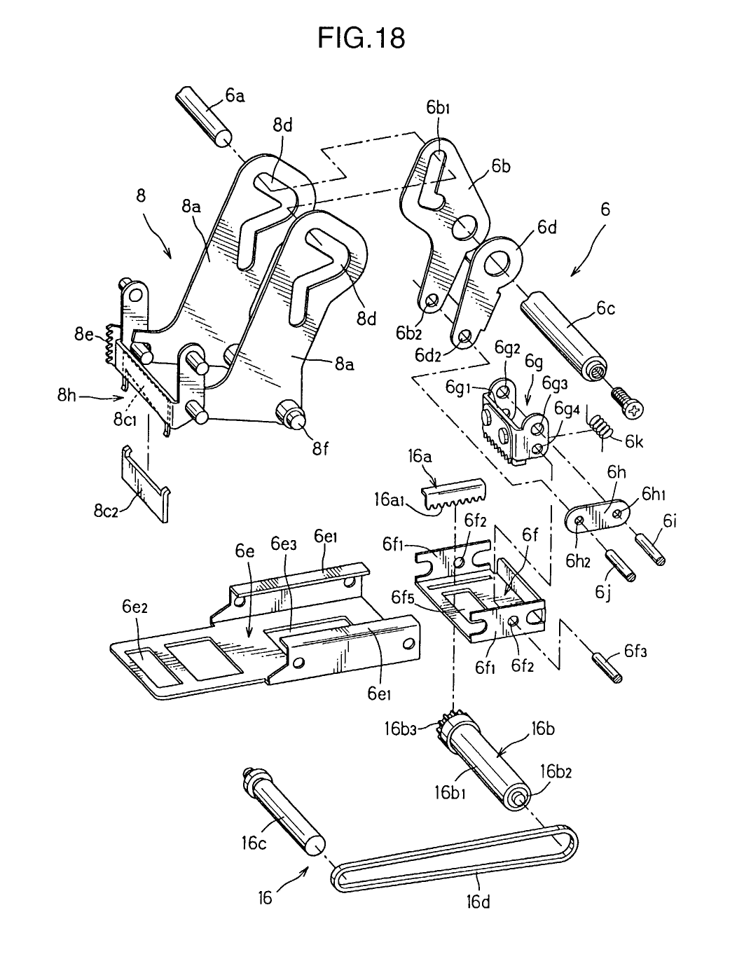

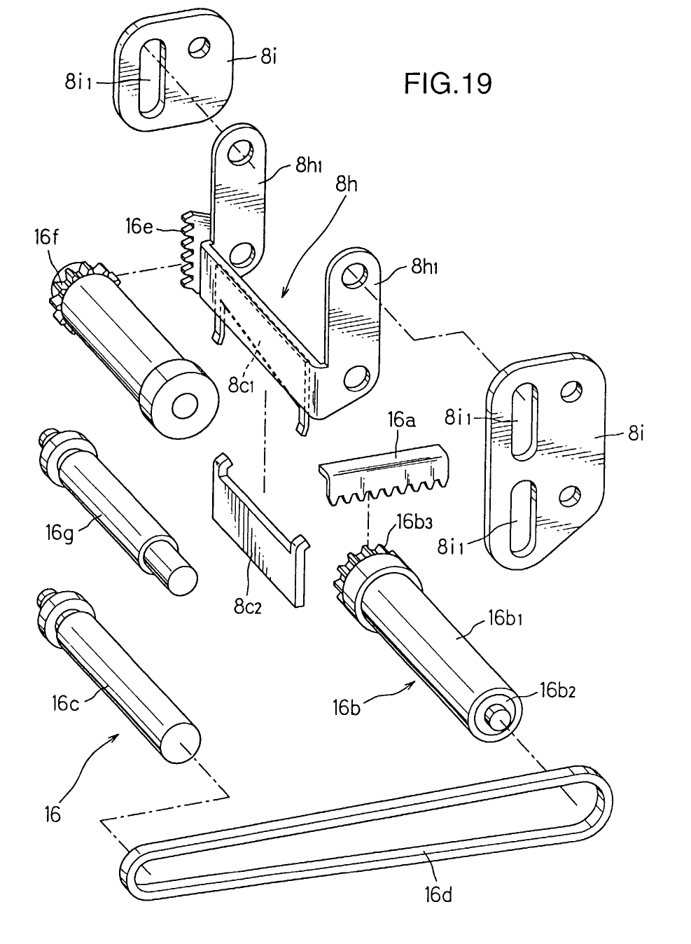

Referring to FIGS. 17 and 19, the press roll adhesive-activating mechanism 16 comprises a horizontal rack gear 16a fixed to the tape-feeding slider 6f, a first unidirectional clutch roll 16b which is engaged with the rack gear 16a for rotating in only one direction, a pinion roll 16c, a timing endless belt 16d bridging these clutch roll and pinion roll 16b and 16c, a vertical rack gear 16e which is operatively connected to the side link plates 8a of the cutter mechanism 8 for moving up and down in unison with the swinging of the slide link plates 8a, a second unidirectional clutch roll 16f responsive to the displacement of the vertical rack gear 16e for rotating in only one direction, and a press roll 16g associated with the second unidirectional clutch roll 16f for rotating in only one direction. The horizontal rack gear 16a has teeth 16a, formed on its lower edge. As seen from FIG. 18, the horizontal rack gear 16a is fixed to one longitudinal side of the slider 6f to be engaged with the clutch gear 16b₃ of the first unidirectional clutch roll 16b.

The first unidirectional clutch roll 16b comprises an outermost cylinder 16b₁, an inner cylinder 16b₂ fitted in the outermost cylinder 16b₁, and a clutch gear 16b₃ fixed to one end. The inner cylinder 16b₂ has wedge recesses (not shown) formed on its circumference, leaf springs (not shown) press-fitted in the wedge recesses, and locking bars (not shown) spring-biased with the leaf-springs to be applied to the inner surface of the outermost cylinder 16b₁.

When the horizontal rack gear 16a is moved forward to rotate the clutch gear 16b₃ counterclockwise, the outermost cylinder 16b₁ is made to turn counterclockwise thanks to the engagement of the locking bar with the wedge recesses, thus driving the timing endless belt 16d forward. When the horizontal rack gear 16a is moved backward to rotate the clutch gear 16b₃ clockwise, the inner cylinder 16b₁ is made to turn clockwise, but the outermost cylinder 16b₁ remains still, thus not allowing the timing endless belt 16d to move forward.

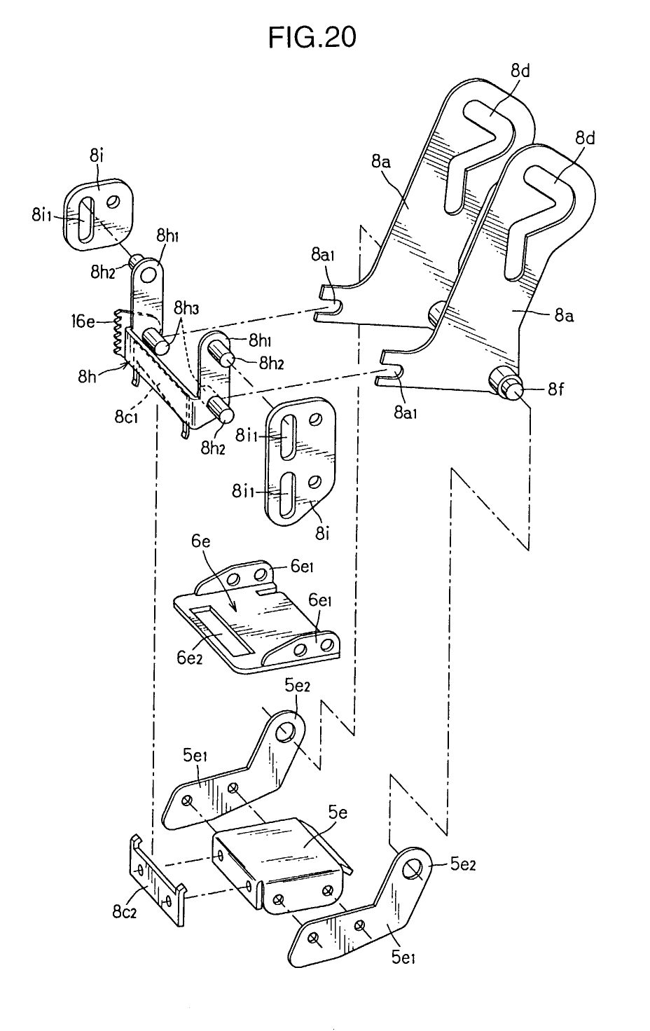

Referring to FIG. 20, the vertical rack gear 16e is fixed to an upper cutter blade mount 8h, which is loosely connected to the lower projecting ends of the opposite side link plates 8a of the cutter mechanism 8.

As shown, the upper cutter blade mount 8h holds a cutter blade 8c₁, and its opposite vertical arms 8h₁ has first upper, outward-projecting stud rods 8h₂ and second lower, inner-projecting stud rods 8h₃. The upper cutter blade mount 8h is attached to vertical movement converting pieces 8i (later described) with its first stud rods 8h₁ inserted in the slots 8i₁ of the vertical movement converting pieces 8i, and the upper cutter blade mount 8h is attached to the lower projecting ends of the opposite side link plates 8a with its second stud rods 8h₃ loosely fitted in the open slots 8a₁ of the lower projecting ends of the opposite side link plates 8a.

When the lower projecting ends of the opposite side link plates 8a are tilted upward about the pivot axle 8f, the upper cutter blade mount 8h is raised vertically by allowing its first stud rods 8h₂ in the vertical slots 8i₁ of the vertical movement converting pieces 8i, and accordingly the cutter blade 8c₁ is raised vertically.

Then, the vertical rack gear 16e is displaced upward to rotate the second unidirectional clutch roll 16f counterclockwise, not making the press roll 16g rotate.

In contrast, when the vertical rack gear 16e is displaced downward to rotate the second unidirectional clutch roll 16f clockwise, making the press roll 16g rotate.

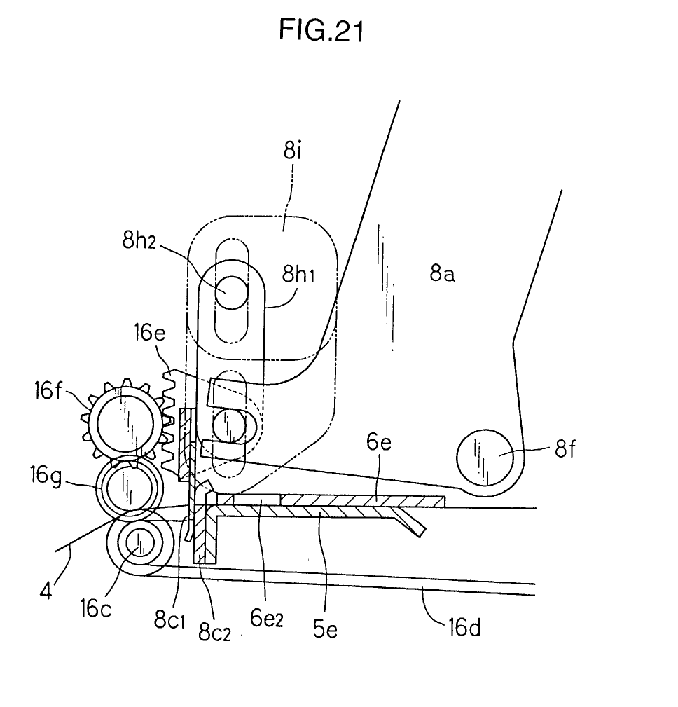

Referring to FIG. 21, a lower cutter blade 8c₂ is placed below the upper cutter blade mount 8h, and ahead of the stamping plate 5e. The lower cutter blade 8c₂ is supported by the opposite side link plates 8a, and more specifically by the pivot axle 8f via a pair of elbows 5e₁, which supports the stamping plate 5e, also (see FIG. 20).

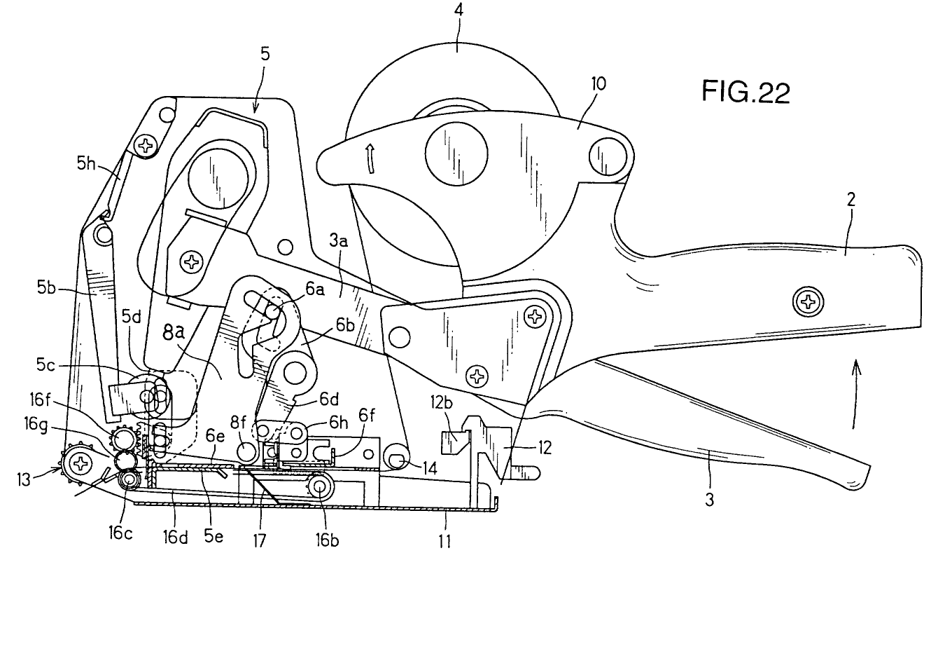

As seen from FIG. 22, a counter nail 17 of thin metal plate is fixed to the inner surface of the bottom lid plate 11. The counter nail 17 has saw-teeth formed on its top. The saw-teeth is so oriented as to allow the forward-feeding of the tape 4, but prevent withdraw of the tape 4.

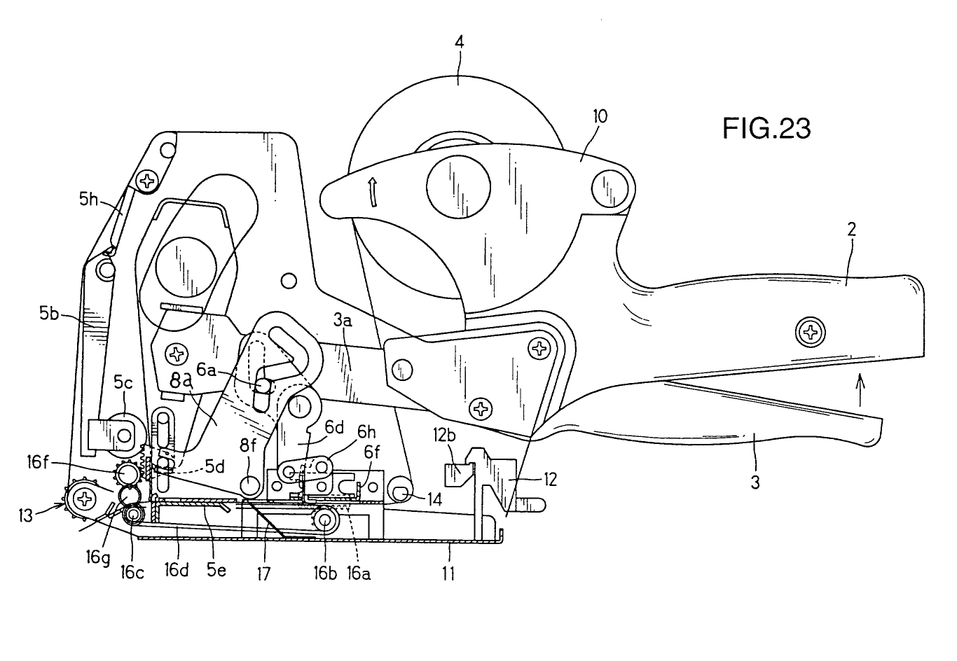

In operation, the handle 3 is griped to move about one third (⅓) angular distance toward the shank extension 2, thereby inclining the rotary arm 3a about its pivot to allow the type face 5d to abut on the ink pad 5c (see FIG. 22). Another one third (⅓) angular gripping of the handle 3 makes the type face 5d to descend and drive the ink pad 5c apart from the way, and at the same time the cam link plates 8a are tilted about their pivot 8f to raise their lower, front projecting ends. Thus, the upper cutter blade mount 8h is raised vertically to bring the upper cutter blade 8c₁ up to a higher level (see FIG. 23).

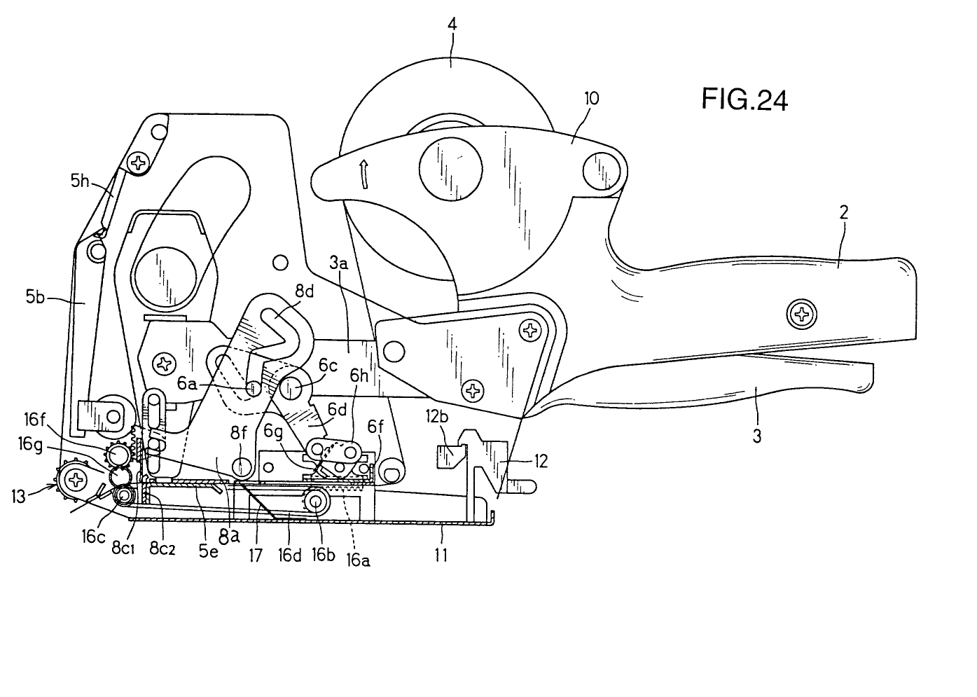

When the handle 3 is completely gripped to lie on the shank extension 2, the tape feeding lever 6d is moved to drive the slider 6f backward, and at the same time, the joint piece 6h is tilted to raise the tape feeding nail 6g. The type face 5d is allowed to print on the tape 4 (see FIG. 24).

Then, the handle 3 is released to move about one half (½) angular distance apart from the shank extension 2, the tape feeding nail 6g is allowed to return to its initial upright posture, thus catching the underlying tape 4, and then the slider 6f is moved forward to feed the tape 4 a predetermined distance equal to the label size.

At the same time, the timing endless belt 16d is moved in unison with the vertical rack gear 16e and the unidirectional clutch roll 16b to rotate the press roll 16g.

Further opening of the handle 3 (about ¾ of the full opening) causes the upper cutter blade 8c₁ to descend and cut the tape 4 close to the printing in cooperation with the lower cutter blade 8c₂like scissors. When the handle 4 is completely released, the upper cutter blade 8cl is raised, and the pressing roll 16g is rotated in unison with the vertical rack gear 16e and the unidirectional clutch 16f to feed the label ahead of the pressing roll 16g. At the same time, the micro capsules are pressed and broken to make the rear side of the label sticky for applying the same to a selected good.

Examples of encapsulated adhesive tape are: (1) a pressure-sensitive type of encapsulated adhesive tape; (2) a solvent-activated type of encapsulated adhesive tape; (3) a thermo-activated type of encapsulated adhesive tape; and (4) a resin-setting type of encapsulated adhesive tape.

The pressure-sensitive type of encapsulated tape has glue or adhesive agent encapsulated, and spread on its rear side. Otherwise, the tape has primary adhesive agent and secondary solvent agent both encapsulated and spread on its rear side. When the tape is subjected to pressure strong enough to break micro-capsules, the rear side of the tape is made sticky.

The primary adhesive agent is a permanent type of adhesive agent having a required adhesive strength. It must be nonaqueous, and cannot be chemically reactive with the capsule material. The capsule size is preferably in the range from 500 to 1500 microns, depending on its viscosity.

The solvent-activated type of encapsulated adhesive tape has solvent encapsulated and dispersed in its adhesive coating. Application of pressure to the tape permits quick activation of the xero-adhesive coating. This particular type of adhesive tape can be used conveniently because of its dryness and quick activation for use.

The thermo-activated type of encapsulated tape has plasticizer and/or adhesive-donor agent encapsulated and dispersed in its resin or elastomer coating. The primary adhesive agent is water-soluble, and the tape, therefore, is less expensive than other encapsulated adhesive tapes; the primary agent is water-based, permitting the condensed capsule slurry to be added to the primary agent just prior to use, thus making it unnecessary to dry wet capsules beforehand.

The resin-setting type of encapsulated tape uses a liquescence of: mixture of encapsulated primary agent and hardener; mixture of encapsulated hardener and primary agent; or mixture of primary agent and hardener both encapsulated.

A hand labeler according to the present invention is described as applying glue or any other adhesive agent to a length of liner-free tape at the final step, but it may be modified to permit use an adhesive tape, which is sticky on its rear side. The hand labeler according to the second embodiment using an endless belt conveyor is appropriate for the purpose. Then, the glue applying mechanism, the liquid applying mechanism, the heating mechanism or the activating mechanism is unnecessary, and accordingly the manufacturing cost can be reduced.

What is claimed is:

1. A labeling method for applying labels to objects such as goods comprising the steps of:
printing pieces of information such as cost on a continuous narrow length on one side to feed it a predetermined distance in a given direction subsequent to each printing;
making the other side of each information bearing length thus fed sticky with the aid of applying means by applying an adhesive agent such as glue, or by applying a liquid-phase additive such as water, plasticizer, activator or solvent to the continuous narrow length having a sticky material already applied to the other side, the required application being effected simultaneously with, before or after the feeding of the continuous narrow length;
cutting and separating each information bearing length from the continuous narrow length to provide individual labels; and
applying the so provided individual labels to objects one after another.

2. A labeling method according to claim 1, wherein the applying means comprises:
brushing or atomizing means for applying an adhesive agent or a liquid-phase additive such as water, plasticizer, activator or solvent to each information bearing length; and
heating and/or pressing means for heating each information bearing length at a predetermined temperature and/or applying a predetermined pressure thereto for example with the aid of rolls, thereby increasing the adhesive strength or activating the adhesive action.

3. A labeling method according to claim 1, wherein the continuous narrow length is a length of paper tape having no release liner or backing liner applied to its rear side.

4. A hand labeler comprising:
printing pieces of information on one side of a continuous narrow length;
a feeding mechanism for feeding the continuous narrow length a predetermined distance in a given direction; and
a cutter mechanism for cutting the so fed part of continuous narrow length when the handle is released to allow it to return to its stress-free position.

5. A hand labeler according to claim 4, wherein it further comprises applying means for applying an adhesive agent such as glue to the other side of the so fed part of continuous narrow length.

6. A hand labeler according to claim 4, wherein it further comprises applying means for applying to the other side of the so fed part of continuous narrow length a liquid-phase additive such as water, plasticizer, activator or solvent.

7. A hand labeler according to claim 4, wherein it further comprises heating means for heating the so fed part of continuous narrow length at a predetermined temperature thereby increasing the adhesive strength.

8. A hand labeler according to claim 4, wherein it further comprises roll means for applying a predetermined pressure to the so fed part of continuous narrow length, thereby activating the adhesive action.

9. A hand labeler according to claim 6, 7 or 8 wherein the continuous narrow length is a length of tape having adhesive agent such as glue encapsulated and spread on the other side or a length of tape having an adhesive agent applied on the other side, and liquid-phase additive such as water, plasticizer, activator or solvent encapsulated and spread on the other side.

10. A hand labeler for printing, cutting and separating a length of tape into individual labels, the tape having adhesive agent such as glue applied or encapsulated and spread on the rear side opposite to the front side on which pieces of information are to be printed, or the tape having an adhesive agent applied on the rear side, and liquid-phase additive such as water, plasticizer, activator or solvent encapsulated and spread on the rear side, said hand labeler being so configured that micro-capsules are destroyed with pressure applying means such as rolls to activate the adhesive agent applied on the length of tape, and that the length of tape is cut a predetermined length sequentially to apply individual labels thus provided to goods one after another.
